(19) United States
(12) Patent Application Publication
(10) Pub. No.: US 2026/0002539 A1
(43) Pub. Date: Jan. 1, 2026

(54) INTELLIGENT DUAL DRIVE PUMP AND WATER SUPPLY SYSTEM

(71) Applicants: QINGDAO SANLI INTELLIGENT POWER CO., LTD., QINGDAO, Shandong Province (CN); QINGDAO SANLI ZHONGDE MEI WATER EQUIPMENT CO., LTD., QINGDAO, Shandong Province (CN); QINGDAO SANLI GROUP CO., LTD., QINGDAO, Shandong Province (CN); QINGDAO SANLI PUMPING INDUSTRY CO., LTD., QINGDAO, Shandong Province (CN)

(72) Inventors: MINGLIANG ZHANG, QINGDAO, SHANDONG PROVINCE (CN); XINGFU GAO, QINGDAO, SHANDONG PROVINCE (CN)

(21) Appl. No.: 18/993,961

(22) PCT Filed: Jul. 11, 2023
(86) PCT No.: PCT/CN2023/106804

§ 371 Date: Jul. 14, 2025

(30) Foreign Application Priority Data
Jul. 12, 2022 (CN) 202210816044.6
Jul. 10, 2023 (CN) 202310839461.7

(51) Int. Cl. F04D 13/06; F04D 29/40

(52) U.S. Cl. CPC F04D 13/06; F04D 29/406

(57) ABSTRACT

Disclosed are an intelligent dual drive pump and a water supply system. The intelligent dual drive pump comprises a pump housing, an impeller, motors, and a controller; the impeller is rotatably arranged in the pump housing, the motors are arranged at one of two respective sides of the pump housing, and the two motors are symmetrically arranged and configured to simultaneously drive the impeller to rotate; the controller is provided with a frequency conversion module used for adjusting a power supply frequency, and the frequency conversion module is configured to adjust the power supply frequency of the motors. A rotor and the impeller are coaxially arranged, the motors and the water pump are an integral whole, the head of the intelligent dual drive pump is increased, and the water supply efficiency of the intelligent dual drive pump is improved.

### TECHNICAL FIELD

The present invention relates to the field of motor technology, particularly to an intelligent dual drive pump and a water supply system.

### BACKGROUND TECHNOLOGY

Water pumps are currently ubiquitous in both everyday life and industrial production. A typical water pump comprises a motor, a pump housing, and an impeller. The pump housing is provided with an inlet and an outlet, with the impeller positioned inside and driven by the motor to rotate, thereby facilitating water flow. However, conventional water pumps are constrained by the motor's power supply frequency and the impeller's driving mode, resulting in limited lift and low water supply efficiency.

### SUMMARY OF THE INVENTION

### Technical Problem

The technical problem to be solved by the present invention is how to design a technology that increases the lift and improves the water supply efficiency.

### Technical Solution

The technical problem that the present invention aims to solve is: providing an intelligent dual drive pump and a water supply system to achieve an increase in the lift of the intelligent dual drive pump and improve the water supply efficiency of the intelligent dual drive pump.

The technical solution provided by the present invention is an intelligent dual drive pump, comprising a pump housing, an impeller, motors, and a controller; the impeller is rotatably disposed within the pump housing, the pump housing is equipped with the motors on both sides, and the two motors are symmetrically arranged and configured to simultaneously drive the impeller to rotate; the controller is configured with a variable frequency module for adjusting the power supply frequency, and the variable frequency module is configured to adjust the power supply frequency of the motors.

Furthermore, the pump also includes a flow detection module; the flow detection module comprises a support frame, a detection pipe, and a flow meter, the support frame is disposed within the pump housing, the detection pipe is disposed on the support frame and suspended within the pump housing, the sensor of the flow meter is disposed within the detection pipe, and the controller is electrically connected to the flow meter.

Furthermore, the detection pipe is further provided with a first guide vane, the first guide vane extends along the axis of the detection pipe and is disposed on the inflow side of the sensor.

Furthermore, the detection pipe is further provided with a second guide vane, the second guide vane extends along the axis of the detection pipe and is disposed on the outflow side of the sensor.

Furthermore, the detection pipe forms an installation cavity internally, and the detection pipe forms an inflow passage and an outflow passage, which are respectively connected to the installation cavity.

Furthermore, the pump housing forms a pressure chamber internally, the pressure chamber is provided with suction ports on both sides, the pump housing is provided with an inlet pipe and an outlet pipe, the outlet pipe communicates with the pressure chamber, and the inlet pipe communicates with the suction ports; the pump housing is further provided with a rotatable main shaft, the main shaft penetrates the pressure chamber, and both ends of the main shaft extend outward from the pump housing.

The impeller is disposed on the main shaft and located within the pressure chamber, the impeller is also located between the two suction ports and is configured to draw water from the inlet pipe through the suction ports into the pressure chamber and discharge it from the outlet pipe.

The motor comprises a casing, a stator, and a rotor, the first end of the casing is provided with a first bearing, the second end of the casing is provided with a second bearing, the second end of the casing is further provided with a through hole, the second bearing is disposed in the through hole; the stator is disposed within the casing, the rotor is rotatably disposed within the casing; the second end of the casing is disposed on the pump housing, the main shaft enters the casing through the through hole and is disposed on the first bearing and the second bearing, the rotor is disposed on the main shaft.

Wherein the pump housing is provided with a first water inlet passage and a first water return passage, the first water inlet passage communicates with the pressure chamber, the first water return passage communicates with the inlet pipe; the casing is provided with a second water inlet passage and a second water return passage, the first end of the casing is further provided with a cooling passage, the cooling passage connects the second water inlet passage and the second water return passage and is disposed on the outer side of the first bearing, the second water inlet passage is connected to the first water inlet passage, the second water return passage is connected to the first water return passage; additionally, the pump housing and the impeller form a water pump, the rotors of the two motors, the impeller of the water pump are fixedly connected to the main shaft, the pump housing is equipped with the motors on both sides, the second ends of the casings of the two motors are fixed to the pump housing to form a coaxial integrated structure of the motors and the water pump.

Furthermore, the casing comprises a shell, a first end cover, and a second end cover, the shell is disposed between the first end cover and the second end cover, the stator is disposed within the shell, the first bearing is disposed on the first end cover, the second bearing is disposed on the second end cover; the outer surface of the first end cover is provided with a cooling water groove, the cooling water groove is disposed on the outer side of the first bearing, the first end cover is further provided with a sealing component, the sealing component seals and covers the cooling water groove, the sealing component and the cooling water groove form the cooling passage. Wherein the second end cover is fixedly connected to the pump housing.

Furthermore, the pump housing comprises a first pump body and a second pump body, the first pump body is provided with a water inlet groove, both sides of the first pump body are provided with a first installation notch, the water inlet groove communicates with the inlet pipe, the water inlet groove is further provided with a protruding structure, the protruding structure divides the water inlet groove into two first water inlet slots, the first water inlet slots respectively communicate with the inlet pipe, the protruding structure forms a first arc-shaped groove, both sides of the protruding structure are further provided with a first water inlet notch, the first arc-shaped groove communicates with the outlet pipe.

The second pump body forms a second arc-shaped groove, both sides of the second arc-shaped groove of the second pump body are sequentially provided with a second water inlet notch, a second water inlet slot, and a second installation notch.

The second pump body is disposed on the first pump body, the first arc-shaped groove and the second arc-shaped groove connect to form the pressure chamber, the first water inlet notch and the corresponding second water inlet notch connect to form the suction port, the first water inlet slot and the corresponding second water inlet slot connect to form a water inlet cavity, the water inlet cavity communicates with the pressure chamber through the suction port; the first installation notch and the corresponding second installation notch connect to form an axle hole, the main shaft passes through the suction port and is dynamically sealed in the axle hole.

The water inlet cavity is provided with a guide component, the guide component is provided with a through hole, the guide component is further provided with a guide surface, the guide surface is generally conical and is configured to guide the water flow in the water inlet cavity towards the suction port.

Furthermore, the guide surface is further provided with a protruding guide rib, the guide rib extends along the axis of the main shaft towards the suction port, the two sides of the guide rib form an arc-shaped surface, the arc-shaped surface is configured to guide the water flow in the water inlet cavity towards the suction port.

The first water inlet passage is further provided with a branch passage, the inner wall of the through hole and the outer wall of the main shaft form a first auxiliary passage.

The axle hole is provided with a mechanical seal assembly, the mechanical seal assembly comprises a mechanical seal cover, a static seal ring, and a dynamic seal ring, the static seal ring is disposed on the mechanical seal cover, the dynamic seal ring and the static seal ring form a dynamic seal area where they contact; the mechanical seal cover is sealed in the axle hole, the main shaft passes through the mechanical seal assembly, the guide component is fixed on the mechanical seal, and the dynamic seal ring is disposed on the main shaft.

The guide component is provided with a second auxiliary passage, the branch passage is connected to the first auxiliary passage through the second auxiliary passage, and the outlet of the second auxiliary passage directs the water flow towards the dynamic seal area.

The present invention also provides a water supply system, comprising a water supply pipe and the aforementioned intelligent dual drive pump, wherein the intelligent dual drive pump is connected to the water supply pipe.

### Beneficial Effects

Compared with the prior art, the advantages and positive effects of the present invention are: The present invention provides an intelligent dual drive pump and water supply system. By configuring two motors on the pump housing and using the two motors to simultaneously drive the impeller to rotate on both sides, the torque of the impeller is effectively increased. Additionally, the two motors synchronously drive the impeller to rotate, making the impeller subject to uniform forces on both ends, thereby rotating more stably. Correspondingly, the variable frequency module can change the frequency of the power supply network, allowing the motor's speed to be doubled, and thus enabling the impeller to rotate stably under the drive of the high-speed motors on both sides, achieving an increase in the lift of the intelligent dual drive pump and improving the water supply efficiency of the intelligent dual drive pump.

### BRIEF DESCRIPTION OF THE DRAWINGS

To more clearly illustrate the technical solutions in the embodiments of the present invention or the prior art, the following briefly introduces the drawings required for the description of the embodiments or the prior art. Obviously, the drawings in the following description are only some embodiments of the present invention, and other drawings can be obtained by those skilled in the art without creative effort based on these drawings.

FIG. 1 is a structural schematic diagram of the first embodiment of the intelligent dual drive pump of the present invention;

FIG. 2 is another structural schematic diagram of the first embodiment of the intelligent dual drive pump of the present invention;

FIG. 3 is a cross-sectional view of the first embodiment of the intelligent dual drive pump of the present invention;

FIG. 4 is a cross-sectional view of the flow detection module in FIG. 1;

FIG. 5 is another cross-sectional view of the flow detection module in FIG. 1;

FIG. 6 is a structural schematic diagram of the second embodiment of the intelligent dual drive pump of the present invention;

FIG. 7 is another structural schematic diagram of the second embodiment of the intelligent dual drive pump of the present invention;

FIG. 8 is a cross-sectional view of the second embodiment of the intelligent dual drive pump of the present invention;

FIG. 9 is a partial enlarged view of area A in FIG. 8;

FIG. 10 is an assembly diagram of the main shaft, rotor, and impeller in FIG. 6;

FIG. 11 is a structural schematic diagram of the casing in FIG. 6;

FIG. 12 is an exploded view of the casing in FIG. 11;

FIG. 13 is a partial enlarged view of area B in FIG. 12;

FIG. 14 is a structural schematic diagram of the first pump body in FIG. 6;

FIG. 15 is a structural schematic diagram of the second pump body in FIG. 6;

FIG. 16 is a structural schematic diagram of the guide component in FIG. 6.

### DETAILED DESCRIPTION OF THE EMBODIMENTS

To make the purpose, technical solution, and advantages of the embodiments of the present invention clearer, the following will describe the technical solutions in the embodiments of the present invention clearly and completely with reference to the accompanying drawings. Obviously, the described embodiments are only some of the embodiments of the present invention, not all of them. Based on the embodiments of the present invention, all other embodiments obtained by those skilled in the art without creative effort fall within the scope of protection of the present invention.

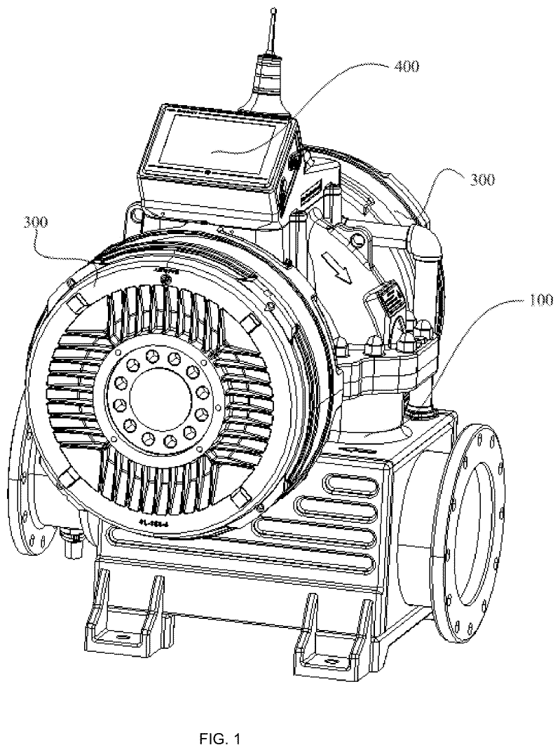

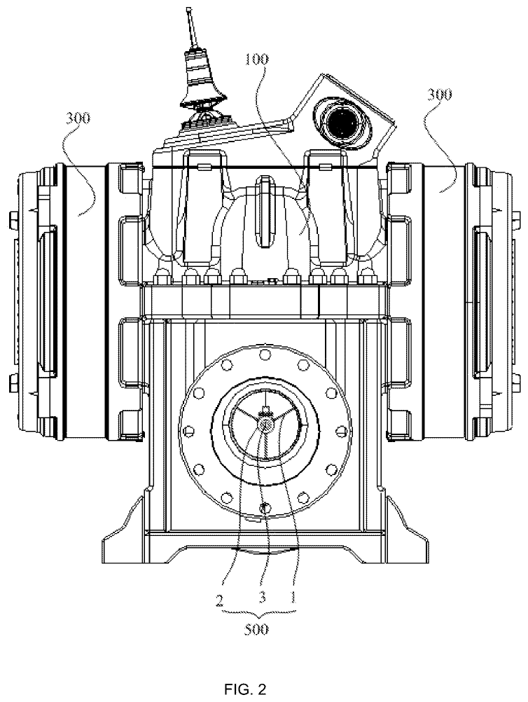

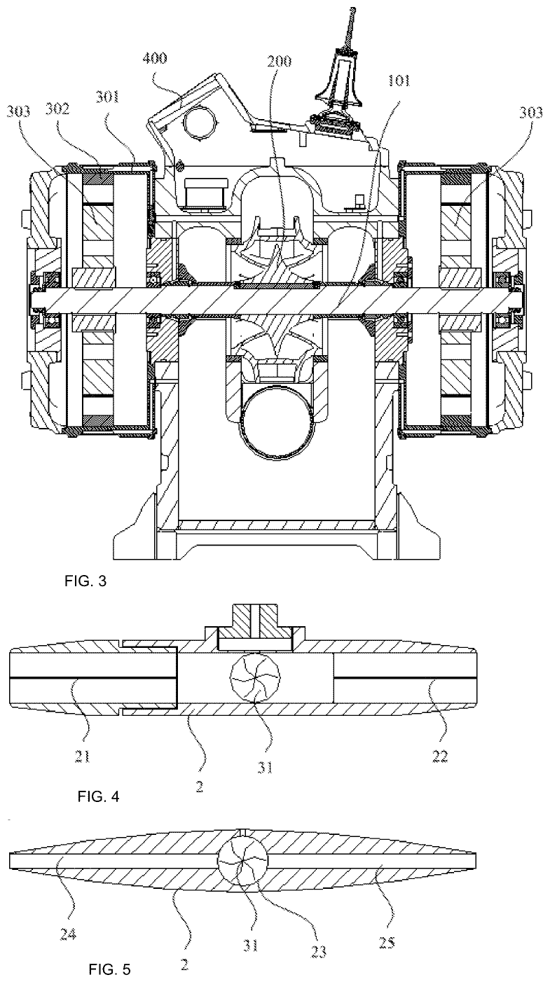

Embodiment one, as illustrated in FIG. 1 to 3, the present invention provides an intelligent dual drive pump, which includes a pump housing 100, an impeller 200, motors 300, and a controller 400. The impeller 200 is rotatably disposed within the pump housing 100, and each side of the pump housing 100 is provided with the motor 300. Both motors 300 work simultaneously to drive the impeller 200 to rotate. The controller 400 includes a variable frequency module (not shown in the figures) to regulate the power supply frequency and is connected to the motors 300.

More specifically, in the present embodiment, the intelligent dual drive pump is provided with two motors 300 that work together to drive the impeller 200 to rotate. During operation, the controller 400 adjusts the power supply frequency via the variable frequency module. For example, if the national grid frequency is 50 Hz/s, the motor 300's speed would be 3000 RPM (50 Hz/s×60 seconds=3000 RPM). To enhance motor 300 efficiency, the variable frequency module can increase the supply frequency to 100 Hz/s, raising the motor 300's speed from 3000 RPM to 6000 RPM, thereby improving the pump's lift and flow rate.

Correspondingly, since the motor 300 operates at high speed, the two motors 300 are externally mounted on the pump housing 100 to ensure stable impeller 200 rotation. The motors 300 drive the impeller 200 simultaneously from both sides. The impeller 200 receives power independently from each motor 300, and the speeds provided by the two motors 300 are synchronized, thereby allowing the impeller 200 to run stably within the pump housing 100 and ensuring stability during high-speed operation.

Furthermore, the motor 300 includes a casing 301, a stator 302, and a rotor 303. The stator 302 and rotor 303 are housed within the casing 301, which is securely attached to the pump housing 100.

Specifically, the motor 300 is fixedly installed on the pump housing 100 through the casing 301, typically using bolts for secure attachment. The motors 300 on either sides of the pump housing 100 are arranged symmetrically to facilitate stable rotation of the impeller 200.

Several methods exist for connecting the motor 300 to the impeller 200. For example, the impeller 200 may be furnished with a shaft that allows it to rotate within the pump housing 100, with the motor 300 shaft being drivingly connected to the said shaft.

Preferably, to achieve a compact design for the overall device and minimize the impact of incorporating two motors 300 on the device's' overall size, the pump housing 100 is provided with a rotatable main shaft 101. Both ends of the main shaft 101 extend outward from the pump housing 100 and into the casing 301. The impeller 200 is disposed on the main shaft 101, and the rotor 303 is disposed on the main shaft 101.

Specifically, the pump housing 100 is configured with the main shaft 101 to satisfy the installation requirements of the rotor 303 of both motors 300 and the impeller 200 through a single main shaft 101. The rotors 303 of the motors 300 are symmetrically installed at both ends of the main shaft 101, driving the main shaft 101 to rotate external to the pump housing 100. The impeller 200 is installed on the main shaft 101 within the pump housing 100. Thus, by transmitting power through a single main shaft 101, on one hand, the two motors 300 can reliably synchronize their rotation, and the motor 300 and the impeller 200 share the main shaft 101, reducing the need for additional transmission components and resulting in a more compact overall device structure.

Concerning the specific embodiment of the controller 400, it can be a control module commonly employed in intelligent motors 300, with the variable frequency module of the controller 400 being a variable frequency drive utilized in variable frequency motors 300. The variable frequency drive can adjust the frequency within the range of 0-400 Hz according to the operating requirements of the motor 300.

Additionally, to facilitate remote monitoring, the controller 400 is provided with a wireless communication module (such as a 4G or a 5G module) to enable remote communication control.

The controller 400 is also provided with a display screen. The motor 300 is provided with a current transformer and a voltage transformer, both electrically connected to the controller 400, thereby displaying the current and voltage of the motor 300 on the display screen. During operation, the flow rate and lift of the water pump can be used to calculate the hydraulic power, and the current and voltage can be used to calculate the electrical power, thereby further determining the efficiency of the water pump. Thus, the controller 400 can display the current and voltage of the motor 300, the flow rate of the water pump, and the efficiency of the water pump on the display screen.

Based on the aforementioned technical solution, optionally, as illustrated in FIG. 1 to 4, a flow detection module 500 includes a support frame 1, a detection pipe 2, and a flow meter 3. The support frame 1 is disposed within the pump housing 100, the detection pipe 2 is mounted on the support frame 1 and suspended within the pump housing 100, and the sensor 31 of the flow meter 3 is located within the detection pipe 2 and electrically connected to the controller 400.

More specifically, the flow detection module 500 is integrated and installed inside the pump housing 100. The detection pipe 2 of the flow detection module 500 is disposed inside the pump housing 100, and the sensor 31 of the flow meter 3 in the flow detection module 500 is disposed inside the detection pipe 2.

Regarding the detection pipe 2, the overall structure of the detection pipe 2 is a straight pipe, and the length of the flow path of the detection pipe 2 being at least five times the diameter of the water flow path inside it, in accordance with national standard requirements for the length of the straight pipe section.

During operation, water flow enters the pump housing 100, and the water flow within the pump housing 100 flows into the detection pipe 2. The water flow passing through the detection pipe 2 flows through the sensor 31, enabling the flow meter 3 performs flow detection.

Given that the length of the flow path of the detection pipe 2 relative to its diameter of the flow meets the national standard requirements for the length of the straight pipe section, the water flow velocity distribution inside the detection pipe 2 is uniform, thereby improving the detection accuracy of the sensor 31.

Moreover, the overall length of the detection pipe 2 is relatively short to meet the installation requirements of the flow meter 3 within a compact space. This design enables the detection pipe 2 to be directly integrated into the pump housing 100, eliminating the need for additional external pipelines to form a straight pipe section.

Furthermore, as shown in FIG. 4, the detection pipe 2 is also provided with a first guide vane 21, which extends along the axis of the detection pipe 2 and is positioned on the inlet side of the sensor 31.

Specifically, the first guide vane 21 in the detection pipe 2 directs the water flow entering the detection pipe 2, which extends along the axial direction of the detection pipe 2, ensuring that the water flow moves more rapidly and smoothly within the detection pipe 2. This improves the balance of the water flow rate within the detection pipe 2. Furthermore, the detection pipe 2 is also provided with a second guide vane 22, which extends along the axis of the detection pipe 2 and is positioned on the outlet side of the sensor 31. Specifically, for the outlet side of the sensor 31 in the detection pipe 2, a second guide vane 22 is similarly configured to facilitate the smooth exit of water flow from the detection pipe 2, further promoting the uniformity of the water flow rate within the detection pipe 2.

As shown in FIG. 5, the interior of the detection pipe 2 forms an installation cavity 23. The detection pipe 2 also forms an inlet flow channel 24 and an outlet flow channel 25, which are connected to the installation cavity 23.

To effectively reduce the overall length of the detection pipe 2 while meeting the installation requirements of the sensor 31, an installation cavity 23 is formed in the middle section of the detection pipe 2 line to install the sensor 31. On either side of the installation cavity 23, the inlet flow channel 24 and outlet flow channel 25 with smaller diameters to the installation cavity 23 are set up. These channels meet the length requirement for the straight pipe section during the detection of the flow meter 3 and help shorten the overall length of the detection pipe 2.

Furthermore, along the direction of water flow inside the pump housing 100, the external dimensions of the detection pipe 2 gradually increase from the inlet flow channel 24 to the installation cavity 23, and then gradually decrease from the installation cavity 23 to the outlet flow channel 25.

Specifically, since the detection pipe 2 is suspended within the pump housing 100 via a support frame 1, to reduce the water resistance caused by the detection pipe 2 to the water flow within the pump housing 100, both the inlet the outlet ends of the detection pipe 2 are designed as conical structures. This design serves to guide the water flow, thereby reducing the water resistance generated.

In some embodiments, to facilitate wiring for the sensor 31, a wiring channel (not labeled) is integrated into the support frame 1. The cables connecting the controller 400 and the sensor 31 are laid in the wiring channel.

Regarding the flow detection module 500, it can be installed at either the inlet or outlet of the pump housing 100, depending on the specific requirements.

The present invention also provides a water supply system, which includes a water supply pipe and the above-mentioned intelligent dual drive pump. The intelligent dual drive pump is connected to the water supply pipe.

Compared with the prior art, the advantages and positive effects of the present invention are as follows: The present invention introduces an intelligent dual drive pump and a water supply system. By configuring two motors 300 on the pump housing 100 and utilizing these two motors 300 to simultaneously drive the impeller 200 to rotate from both sides, the torque of the impeller 200 is effectively increased. Additionally, the synchronous driving of the impeller 200 by the two motors 300 subjects the impeller 200 to uniform forces on both sides, thereby promoting more stable rotation. Correspondingly, the variable frequency module can alter the frequency of the power supply, allowing the speed of the motors to be doubled, and thus enabling the impeller 200 to rotate stably under the drive of the high-speed motors 300 on both sides. This achieves an increase in the lift of the intelligent dual drive pump and improves the water supply efficiency of the intelligent dual drive pump.

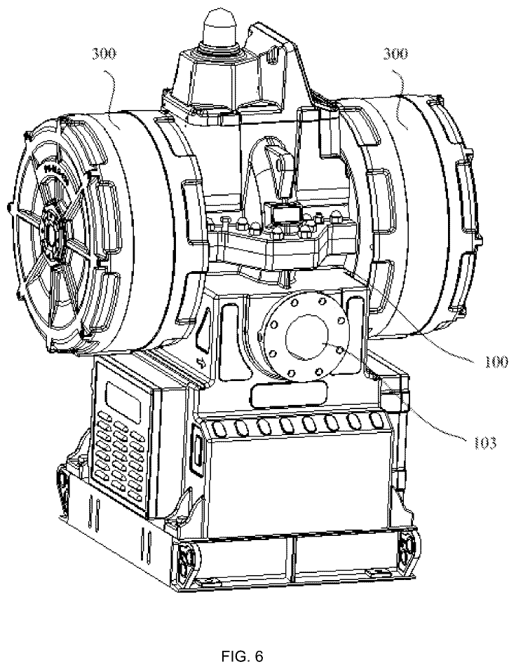

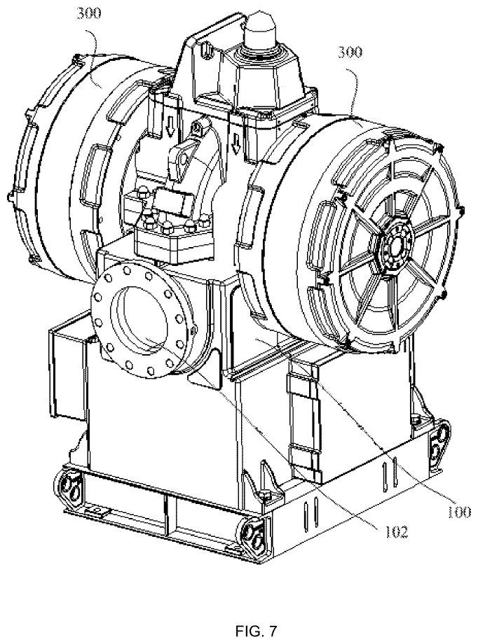

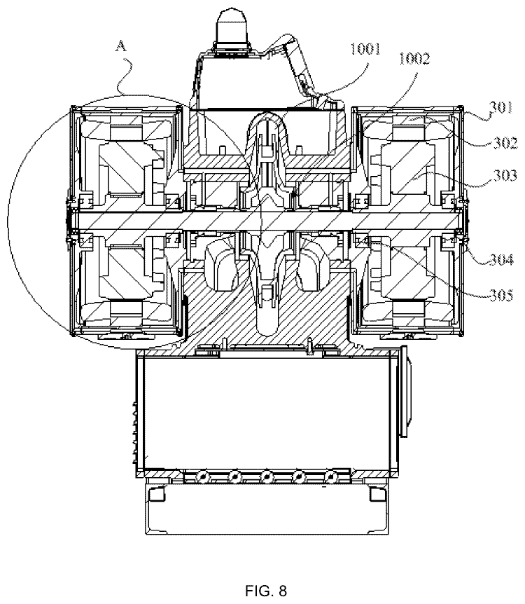

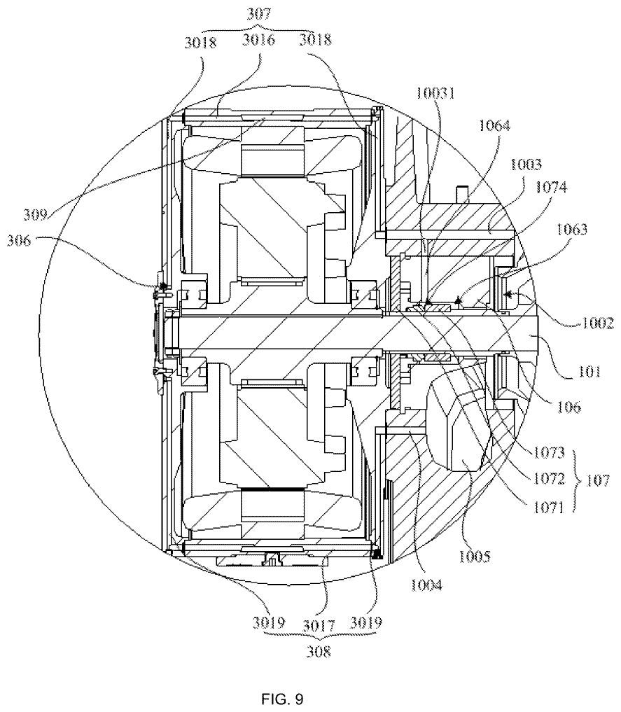

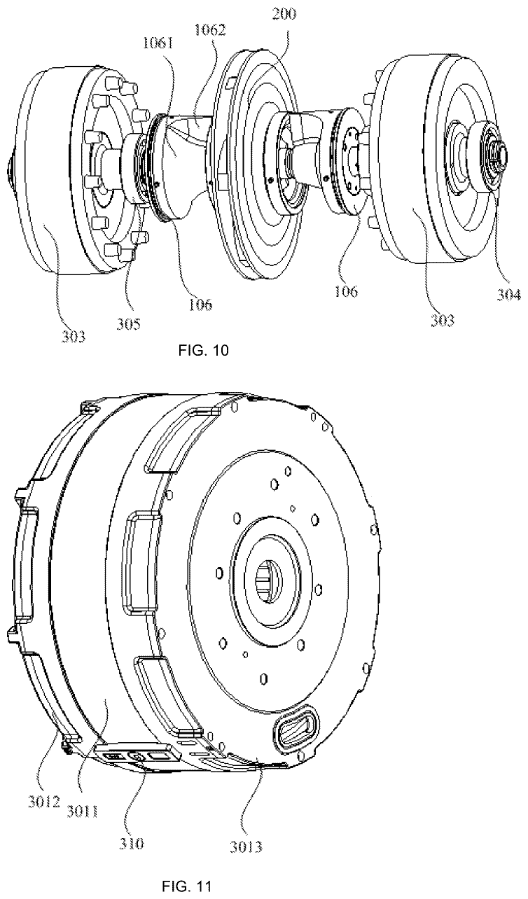

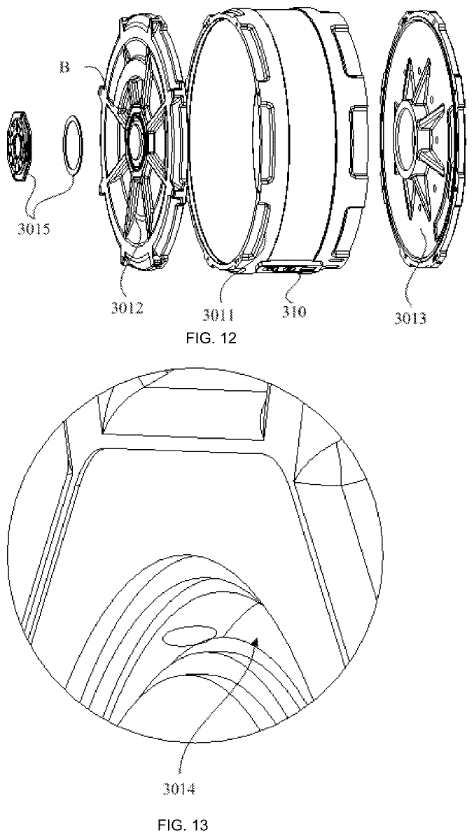

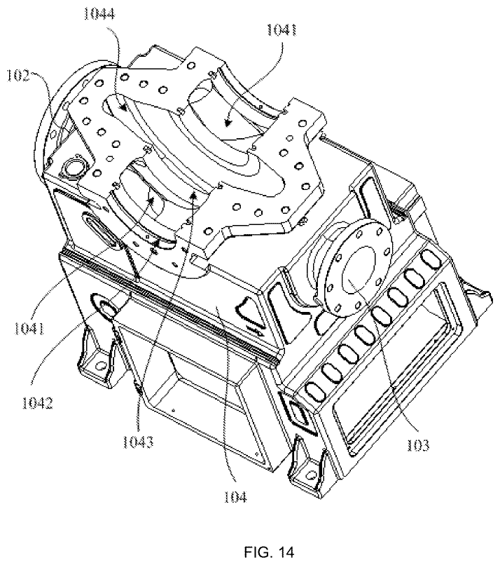

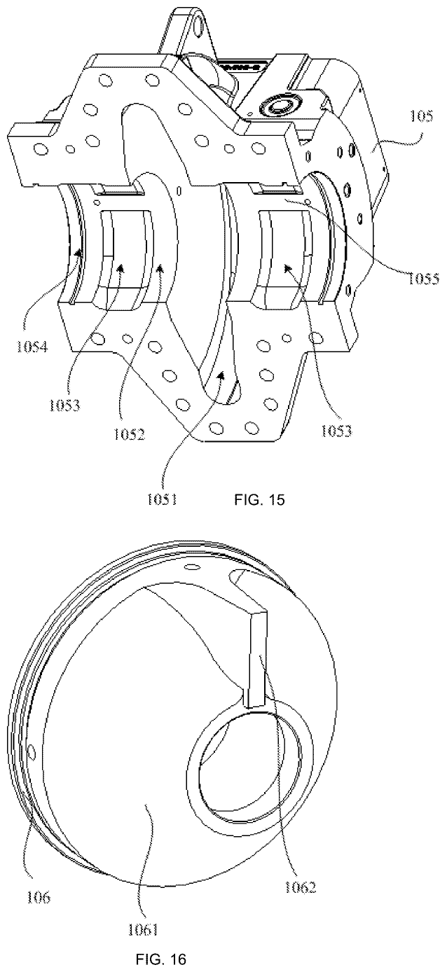

Embodiment two, as shown in FIGS. 6 to 16, based on the above embodiment one, the present invention also provides an intelligent dual drive pump. The intelligent dual drive pump includes a pump housing 100, an impeller 200, motors 300, and a controller 400. The controller 400 is configured with a variable frequency module for adjusting the power supply frequency, and the variable frequency module is configured to adjust the power supply frequency of the motor 300.

The pump housing 100 defines a pressure chamber 1001, which is provided with suction ports 1002 on both sides. The pump housing 100 is provided with an inlet pipe 102 and an outlet pipe 103. The outlet pipe 103 communicates with the pressure chamber 1001, while the inlet pipe 102 communicates with the suction ports 1002. Additionally, the pump housing 100 is provided with a rotatable main shaft 101, which penetrates the pressure chamber 1001 with both ends extending to the exterior of the pump housing 100.

The impeller 200 is disposed on the main shaft 101 and situated within the pressure chamber 1001. Positioned between the two suction ports 1002, the impeller 200 is configured to draw water from the inlet pipe 102 through the suction ports 1002 into the pressure chamber 1001, subsequently discharging it from the outlet pipe 103.

Each of the two motors 300 include a casing 301, a stator 302, and a rotor 303. The first end of the casing 301 is provided with a first bearing 304, while the second end of the casing 301 is provided with a second bearing 305 and a through hole accommodating the second bearing 305.

The stator 302 is housed within the casing 301, and the rotor 303 is rotatably positioned within the casing 301. The second end of the casing 301 is mounted on the pump housing 100. The main shaft 101 enters the casing 301 through the through hole and is supported by the first bearing 304 and the second bearing 305. The rotor 303 is disposed on the main shaft 101.

Moreover, the pump housing 100 is provided with a first water inlet passage 1003 and a first water return passage 1004. The first water inlet passage 1003 communicates with the pressure chamber 1001, while the first water return passage 1004 communicates with the inlet pipe 102. Correspondingly, the casing 301 is provided with a second water inlet passage 307 and a second water return passage 308. The first end of the casing 301 is also fitted with a cooling passage 306, which connects the second water inlet passage 307 and the second water return passage 308 and is disposed on the outer side of the first bearing 304. The second water inlet passage 307 is connected to the first water inlet passage 1003, and the second water return passage 308 is connected to the first water return passage 1004.

During assembly, the main shaft 101 of the pump housing 100 is fitted with the impeller 200 and two rotors 303. The end of the main shaft 101 is inserted into the corresponding side of the casing 301 and is supported and secured on the main shaft 101 by the first bearing 304 and the second bearing 305. The motors 300 on both sides of the pump housing 100 synchronously drive the main shaft 101 to rotate, thereby driving the impeller 200 to rotate in the pressure chamber 1001. The action of the impeller 200 action draws water from the inlet pipe 102 through the suction ports 1002 into the pressure chamber 1001 where it is pressurized and subsequently discharged through the outlet pipe 103.

During the operation of the motor 300, the first bearing 304 and the second bearing 305 generate heat due to the rotation of the main shaft 101. The second bearing 305, being proximate to the pump housing 100, transfers heat to the pump housing 100 through the second end of the casing 301, utilizing the flowing water inside the pump housing 100 for cooling.

Regarding the first bearing 304, being distant from the pump housing 100, it requires an alternative cooling method. A cooling passage 306 is set at the first end of the casing 301, creating a water flow channel that isolates the water from the first bearing 304. Water flowing through the cooling passage 306 absorbs heat from the first bearing 304, ensuring stable operation while keeping the bearing isolated from direct water contact.

The water flowing through the cooling passage 306 is sourced from the pressure chamber 1001. It enters the second water inlet passage 307 of the casing 301 via the first water inlet passage 1003 and then flows into the cooling passage 306. After absorbing heat from the first bearing 304, the water returns to the pump housing 100 through the second water return passage 308 and the first water return passage 1004, continuing its circulation into the pressure chamber 1001.

The implementation of the cooling passage 306 effectively addresses the issue of inadequate cooling of the first bearing 304, enhancing reliability and meeting the high-speed operation requirements of the motor 300, and thus improving the water supply efficiency.

Furthermore, the casing 301 includes a shell 3011, a first end cover 3012, and a second end cover 3013. The shell 3011 is disposed between the first end cover 3012 and the second end cover 3013. The stator 302 is housed within the shell 3011. The first bearing 304 is mounted on the first end cover 3012, while the second bearing 305 is mounted on the second end cover 3013. The outer surface of the first end cover 3012 is provided with a cooling water groove 3014, located on the outer side of the first bearing 304. The first end cover 3012 is also provided with a sealing component 3015, which seals and covers the cooling water groove 3014, thereby forming the cooling passage 306.

The second end cover 3013 is provided with a through hole and is fixedly connected to the pump housing 100.

Specifically, the casing 301 utilizes an annular structure of the shell 3011 to accommodate the stator 302. The first end cover 3012 and the second end cover 3013 are connected to both sides of the shell 3011 to form the casing 301. The first end cover 3012 is used to mount the first bearing 304, while the second end cover 3013 is used to mount the second bearing 305. To create the cooling passage 306, a cooling water groove 3014 is formed on the first end cover 3012. The cooling water groove 3014 is formed on the outer surface of the first end cover 3012. A sealing component 3015 is then used to cover the cooling water groove 3014, forming a closed cooling passage 306.

Correspondingly, to establish the second water inlet passage 307 and the second water return passage 308, the shell 3011 is equipped with a first passage 3016 and a second passage 3017. The first end cover 3012 and the second end cover 3013 are respectively provided with a third passage 3018 and a fourth passage 3019. The first passage 3016 is connected to the cooling passage 306 through the third passage 3018. The first passage 3016 and the third passage 3018 are connected to form the second water inlet passage 307. The second passage 3017 and the fourth passage 3019 collectively form the second water return passage 308.

Specifically, the first passage 3016 and the second passage 3017 can be formed by drilling holes in the shell 3011. Similarly, the third passage 3018 and the fourth passage 3019 can also be formed by drilling holes, thereby reducing processing complexity.

Moreover, the shell 3011 forms an annular passage 309, which is arranged around the stator 302. The first passage 3016 and the second passage 3017 are connected to the annular passage 309.

To meet the cooling requirements of the stator 302 in the motor 300, the annular passage 309 can be formed in the shell 3011. Cold water is supplied to the annular passage 309 through the first passage 3016, and heated water is returned to the pump housing 100 through the second passage 3017. The annular passage 309 can be formed by opening a groove on the outer wall of the shell 3011 and then sealing the groove with a sealing cover to form a closed annular passage 309.

To prevent air blockage within the cooling passage 306 and the annular passage 309, a vent valve 310 can be installed on the casing 301. The vent valve 310 can be connected to both the second water inlet passage 307 and the second water return passage 308. By opening the vent valve 310, any air in the passages can be released, ensuring unobstructed cooling water flow and reliable heat dissipation.

In one embodiment of the present invention, the pump housing 100 comprises a first pump body 104 and a second pump body 105. The first pump body 104 is provided with a water inlet groove, with both sides provided with a first installation notch 1042. The water inlet groove is connected to the inlet pipe 102 and is divided into two first water inlet slots 1041 by a protruding structure, each slot connecting to the inlet pipe 102. The protruding structure forms a first arc-shaped groove 1044, with both sides provided with a first water inlet notch 1043. The first arc-shaped groove 1044 is connected to the outlet pipe 103.

The second pump body 105 forms a second arc-shaped groove 1051. On both sides of the second arc-shaped groove 1051, the second pump body 105 is sequentially provided with a second water inlet notch 1052, a second water inlet slot 1053, and a second installation notch 1054.

The second pump body 105 is disposed on the first pump body 104, connecting the first arc-shaped groove 1044 with the second arc-shaped groove 1051 to form the pressure chamber 1001. The first water inlet notch 1043 and the corresponding second water inlet notch 1052 are connected to form the suction port 1002. The first water inlet slot 1041 and the corresponding second water inlet slot 1053 are connected to form a water inlet cavity 1005, which communicates with the pressure chamber 1001 through the suction port 1002. The first installation notch 1042 and the corresponding second installation notch 1054 are connected to form an axle hole, through which the main shaft 101 passes and is dynamically sealed.

Specifically, to facilitate the installation of the impeller 200, the pump housing 100 adopts an upper and lower split structure. Upon connecting the first pump body 104 and the second pump body 105, the first arc-shaped groove 1044 and the second arc-shaped groove 1051 are aligned to form the pressure chamber 1001, within which the impeller 200 is located. Simultaneously, the water inlet areas on both sides of the impeller 200 are arranged opposite to the corresponding suction ports 1002.

To ensure balanced water intake for the two suction ports 1002, the first water inlet slot 1041 and the corresponding second water inlet slot 1053 are connected to form the water inlet cavity 1005. This arrangement provides the water inlet cavity 1005 on both sides of the pressure chamber 1001 within the pump housing 100, facilitating balanced water intake for both sides of the pressure chamber 1001.

The first water inlet passage 1003 is disposed on the second pump body 105 and is connected to the second arc-shaped groove 1051, while the first water return passage 1004 is disposed on the first pump body 104 and is connected to the first water inlet slot 1041.

Moreover, as the suction ports 1002 on both sides of the pressure chamber 1001 require a water supply during operation, the pressure chamber 1001 is embedded in the water inlet groove to form the water inlet cavity 1005 on both sides of the pressure chamber 1001. To prevent the formation of vortices around the suction ports 1002 within the water inlet cavity 1005, which could adversely affect water supply efficiency, a guide component 106 can be installed in the water inlet cavity 1005. The guide component 106 is provided with a through hole, and the guide component 106 is further provided with a guide surface 1061. The guide surface 1061 is generally conical and is configured to guide the water flow in the water inlet cavity 1005 towards the suction ports 1002.

Specifically, the inclusion of a guide component 106 within the water inlet cavity 1005 allows the main shaft 101 to pass through the through hole thereon, ensuring the free rotation of the main shaft 101. The guide surface 1061 formed on the guide component 106 is a conical surface, with the taper of the guide surface 1061 oriented towards the suction port 1002. This arrangement guides the water entering the water inlet cavity 1005 from the inlet pipe 102, facilitating a smoother flow into the suction port and subsequently into the pressure chamber 1001.

Preferably, to more effectively address the issue of vortices within the water inlet cavity 1005, the guide surface 1061 is further provided with a protruding guide rib 1062. The guide rib 1062 extends along the axis of the main shaft 101 towards the suction port 1002. The two sides of the guide rib 1062 form an arc-shaped surface, designed to guide the water flow in the water inlet cavity 1005 towards the suction port 1002.

Specifically, the guide rib 1062 protrudes from the guide surface 1061 and extends axially along towards the suction port 1002. For the water entering the water inlet cavity 1005 and circulating around the suction port 1002, the guide rib 1062 blocks the water, preventing the water flow from forming vortices around the suction port 1002. This comprehensive solution effectively mitigates the problem of vortices within the water inlet cavity 1005, ultimately enhancing the water supply efficiency of the intelligent dual drive pump.

Moreover, the arc-shaped surfaces on both sides of the guide rib 1062 further guide the obstructed water flow towards the suction port 1002. The guide surface 1061 and the arc-shaped surfaces collaboratively ensure that the suction port 1002 can smoothly and efficiently draw in water.

To further enhance the effectiveness of the guide rib 1062 in preventing vortex formation, a connecting rib 1055 can be installed in the second water inlet slot 1053. The guide rib 1062 is connected to the corresponding side of the connecting rib 1055.

Additionally, the first water inlet passage 1003 is also provided with a branch passage 10031. The inner wall of the through hole and the outer wall of the main shaft 101 form a first auxiliary passage 1063.

The axle hole is provided with a mechanical seal assembly 107, comprising a mechanical seal cover 1071, a static seal ring 1072, and a dynamic seal ring 1073. The static seal ring 1072 is mounted on the mechanical seal cover 1071. The dynamic seal ring 1073 and the static seal ring 1072 form a dynamic seal area 1074 at their point of contact. The mechanical seal cover 1071 is securely sealed within the axle hole, and the main shaft 101 passes through the mechanical seal assembly 107. The guide component 106 is fixed to the mechanical seal, with the dynamic seal ring 1073 positioned on the main shaft 101.

The guide component 106 is provided with a second auxiliary passage 1064, which connects the branch passage 10031 to the first auxiliary passage 1063. The outlet of the second auxiliary passage 1064 directs the water flow towards the dynamic seal area 1074.

Specifically, the main shaft 101 is installed on the pump housing 100 through the mechanical seal assembly 107. The mechanical seal assembly 107 enables the main shaft 101 to pass through the pump housing 100, achieving a dynamic seal connection. The specific dynamic sealing method employed by the mechanical seal assembly 107 can be accomplished using conventional mechanical sealing methods, which are not limited or further described herein.

In operation, water supplied by the branch passage 10031 flows through the second auxiliary passage 1064 on the guide component 106 into the first auxiliary passage 1063, thereby cooling the mechanical seal assembly 107. Crucially, as the static seal ring 1072 and the dynamic seal ring 1073 rotate relative to each other, sand and other debris in the water can accumulate in the dynamic seal area 1074. This accumulation can cause significant wear between the static seal ring 1072 and the dynamic seal ring 1073, leading to a reduced service life. The water flow exiting the second auxiliary passage 1064 cleans the dynamic seal area 1074 formed between the dynamic seal ring 1073 and the static seal ring 1072, reducing the impact of sand and other debris on the connection between the dynamic seal ring 1073 and the static seal ring 1072. This not only satisfies the cooling requirements but also removes debris, extending the service life of the mechanical seal assembly 107.

Finally, it should be noted that the above embodiments are only used to illustrate the technical solutions of the present invention and are not intended to limit them. Although the invention has been described in detail with reference to the foregoing embodiments, those skilled in the art should understand that they can still modify the technical solutions described in the foregoing embodiments, or equivalently replace some of the technical features. These modifications or replacements do not cause the essence of the corresponding technical solutions to deviate from the spirit and scope of the technical solutions of the embodiments of the present invention.

1: An intelligent dual drive pump, characterized by comprising a pump housing, an impeller, motors, and a controller; wherein the impeller is rotatably disposed within the pump housing, the pump housing is provided with the motors on both sides, and the two motors are symmetrically arranged and configured to simultaneously drive the impeller to rotate; the controller is configured with a variable frequency module for adjusting the power supply frequency, and the variable frequency module is configured to adjust the power supply frequency of the motors.

2: The intelligent dual drive pump according to claim 1, characterized in that the motor comprises a casing, a stator, and a rotor, wherein the stator and the rotor are disposed within the casing, and the casing is fixedly disposed on the pump housing.

3: The intelligent dual drive pump according to claim 2, characterized in that the pump housing is provided with a rotatable main shaft, both ends of the main shaft extend outward from the pump housing and into the casing; wherein the impeller is disposed on the main shaft, and the rotor is disposed on the main shaft.

4: The intelligent dual drive pump according to claim 1, characterized by further comprising a flow detection module; wherein the flow detection module comprises a support frame, a detection pipe, and a flow meter, the support frame is disposed within the pump housing, the detection pipe is disposed on the support frame and suspended within the pump housing, the sensor of the flow meter is disposed within the detection pipe, and the controller is electrically connected to the flow meter.

5: The intelligent dual drive pump according to claim 4, characterized in that the detection pipe is further provided with a first guide vane, the first guide vane extends along the axis of the detection pipe and is disposed on the inlet side of the sensor; the detection pipe is further provided with a second guide vane, the second guide vane extends along the axis of the detection pipe and is disposed on the outlet side of the sensor.

6: The intelligent dual drive pump according to claim 1, characterized in that the pump housing forms a pressure chamber, the pressure chamber is provided with suction ports on both sides, the pump housing is provided with an inlet pipe and an outlet pipe, the outlet pipe communicates with the pressure chamber, and the inlet pipe communicates with the suction ports; the pump housing is further provided with a rotatable main shaft, the main shaft penetrates the pressure chamber, and both ends of the main shaft extend outward from the pump housing;
the impeller is disposed on the main shaft and located within the pressure chamber, the impeller is also located between the two suction ports and is configured to draw water from the inlet pipe through the suction ports into the pressure chamber and discharge it from the outlet pipe;
the motor comprises a casing, a stator, and a rotor, the first end of the casing is provided with a first bearing, the second end of the casing is provided with a second bearing, the second end of the casing is further provided with a through hole, the second bearing is disposed in the through hole; the stator is disposed within the casing, the rotor is rotatably disposed within the casing; the second end of the casing is disposed on the pump housing, the main shaft enters the casing through the through hole and is disposed on the first bearing and the second bearing;
wherein the pump housing is provided with a first water inlet passage and a first water return passage, the first water inlet passage communicates with the pressure chamber, the first water return passage communicates with the inlet pipe; the casing is provided with a second water inlet passage and a second water return passage, the first end of the casing is further provided with a cooling passage, the cooling passage connects the second water inlet passage and the second water return passage and is disposed on the outer side of the first bearing, the second water inlet passage is connected to the first water inlet passage, the second water return passage is connected to the first water return passage; and
the pump housing and the impeller form a water pump, the rotors of the two motors, the impeller of the water pump are fixedly connected to the main shaft, the pump housing is equipped with the motors on both sides, the second ends of the casings of the two motors are fixed to the pump housing to form a coaxial integrated structure of the motors and the water pump.

7: The intelligent dual drive pump according to claim 6, characterized in that the casing comprises a shell, a first end cover, and a second end cover, the shell is disposed between the first end cover and the second end cover, the stator is disposed within the shell, the first bearing is disposed on the first end cover, the second bearing is disposed on the second end cover; the outer surface of the first end cover is provided with a cooling water groove, the cooling water groove is disposed on the outer side of the first bearing, the first end cover is further provided with a sealing component, the sealing component seals and covers the cooling water groove, the sealing component and the cooling water groove form the cooling passage; wherein the second end cover is fixedly connected to the pump housing.

8: The intelligent dual drive pump according to claim 6, characterized in that the pump housing comprises a first pump body and a second pump body, the first pump body is provided with a water inlet groove, both sides of the first pump body are provided with a first installation notch, the water inlet groove communicates with the inlet pipe, the water inlet groove is further provided with a protruding structure, the protruding structure divides the water inlet groove into two first water inlet slots, the first water inlet slots respectively communicate with the inlet pipe, the protruding structure forms a first arc-shaped groove, both sides of the protruding structure are further provided with a first water inlet notch, the first arc-shaped groove communicates with the outlet pipe;
the second pump body forms a second arc-shaped groove, both sides of the second arc-shaped groove of the second pump body are sequentially provided with a second water inlet notch, a second water inlet slot, and a second installation notch;
the second pump body is disposed on the first pump body, the first arc-shaped groove and the second arc-shaped groove connect to form the pressure chamber, the first water inlet notch and the corresponding second water inlet notch connect to form the suction port, the first water inlet slot and the corresponding second water inlet slot connect to form a water inlet cavity, the water inlet cavity communicates with the pressure chamber through the suction port; the first installation notch and the corresponding second installation notch connect to form an axle hole, the main shaft passes through the suction port and is dynamically sealed in the axle hole;
the water inlet cavity is provided with a guide component, the guide component is provided with a through hole, the guide component is further provided with a guide surface, the guide surface is generally conical and is configured to guide the water flow in the water inlet cavity towards the suction port.

9: The intelligent dual drive pump according to claim 8, characterized in that the guide surface is further provided with a protruding guide rib, the guide rib extends along the axis of the main shaft towards the suction port, the two sides of the guide rib form an arc-shaped surface, the arc-shaped surface is configured to guide the water flow in the water inlet cavity towards the suction port;
the first water inlet passage is further provided with a branch passage, the inner wall of the through hole and the outer wall of the main shaft form a first auxiliary passage;
the axle hole is provided with a mechanical seal assembly, the mechanical seal assembly comprises a mechanical seal cover, a static seal ring, and a dynamic seal ring, the static seal ring is disposed on the mechanical seal cover, the dynamic seal ring and the static seal ring form a dynamic seal area where they contact; the mechanical seal cover is sealed in the axle hole, the main shaft passes through the mechanical seal assembly, the guide component is fixed on the mechanical seal, and the dynamic seal ring is disposed on the main shaft;
the guide component is provided with a second auxiliary passage, the branch passage is connected to the first auxiliary passage through the second auxiliary passage, the outlet of the second auxiliary passage directs the water flow towards the dynamic seal area.

10: A water supply system, comprising a water supply pipe, characterized by further comprising the intelligent dual drive pump according to any one of claims 1-9, wherein the intelligent dual drive pump is connected to the water supply pipe.
